(19) United States
(12) Patent Application Publication
(10) Pub. No.: US 2013/0177674 A1
(43) Pub. Date: Jul. 11, 2013

(54) PROCESSED FOOD PRODUCT IN THE SHAPE OF A TANGRAM OR OTHER TILING PUZZLE

(71) Applicant: Sylvia Anne Stein, New York, NY (US)

(72) Inventor: Sylvia Anne Stein, New York, NY (US)

(21) Appl. No.: 13/345,967

(22) Filed: Jan. 9, 2012

(51) Int. Cl. A23G 3/50; A21D 13/00

(52) U.S. Cl. 426/76; 426/104; 426/103; 426/87

(57) ABSTRACT

A set of processed food or snack products in the shape of tiling pieces capable of creating a variety of final geometric or representational shapes. For the purpose of play value, the tiling puzzle challenge is illustrated as the outline final shape. The consumer can configure a set of the edible tiling pieces to form the final shape, before consuming the processed food or snack. For the purpose of decorative presentation, the tiling puzzle solution is illustrated showing the outlines of the individual edible tiling pieces. The consumer can use the illustration to recreate the desired final shape to display the processed food in an attractive manner, before it is consumed.

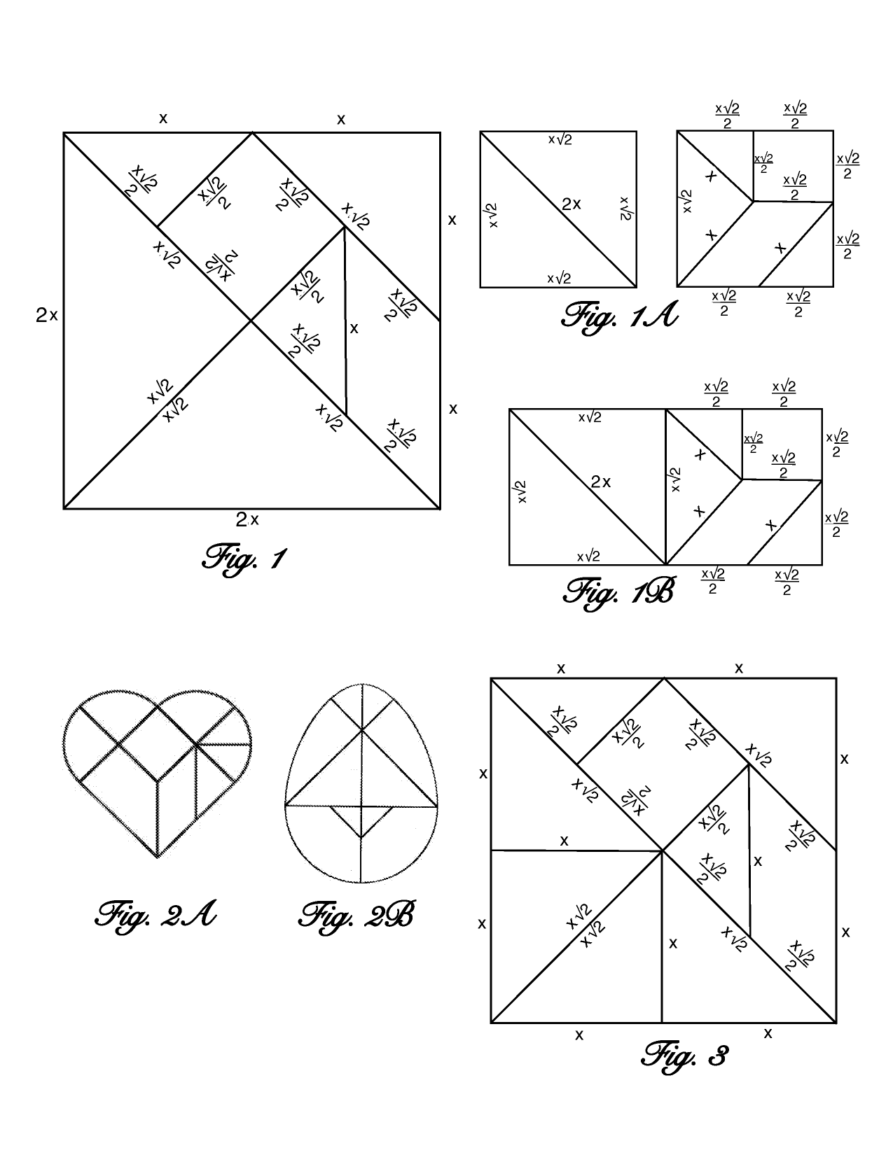

FIG. 1 illustrates the packing shape and top view dimensions for the basic seven Tangram tiling pieces (tans) that constitute a square packing shape (two large triangles, two small triangles, one mid-sized triangle, one square and one rhomboid) where ‘x’ can be a size from 1 cm to 100 cm.

FIGS. 1A/B illustrates alternative packing shapes and top view dimensions for the basic seven Tangram tiling pieces (tans) that constitutes the two squares (FIG. 1A) and the rectangle (FIG. 1B) where ‘x’ can be a measurement from 1 cm to 100 cm

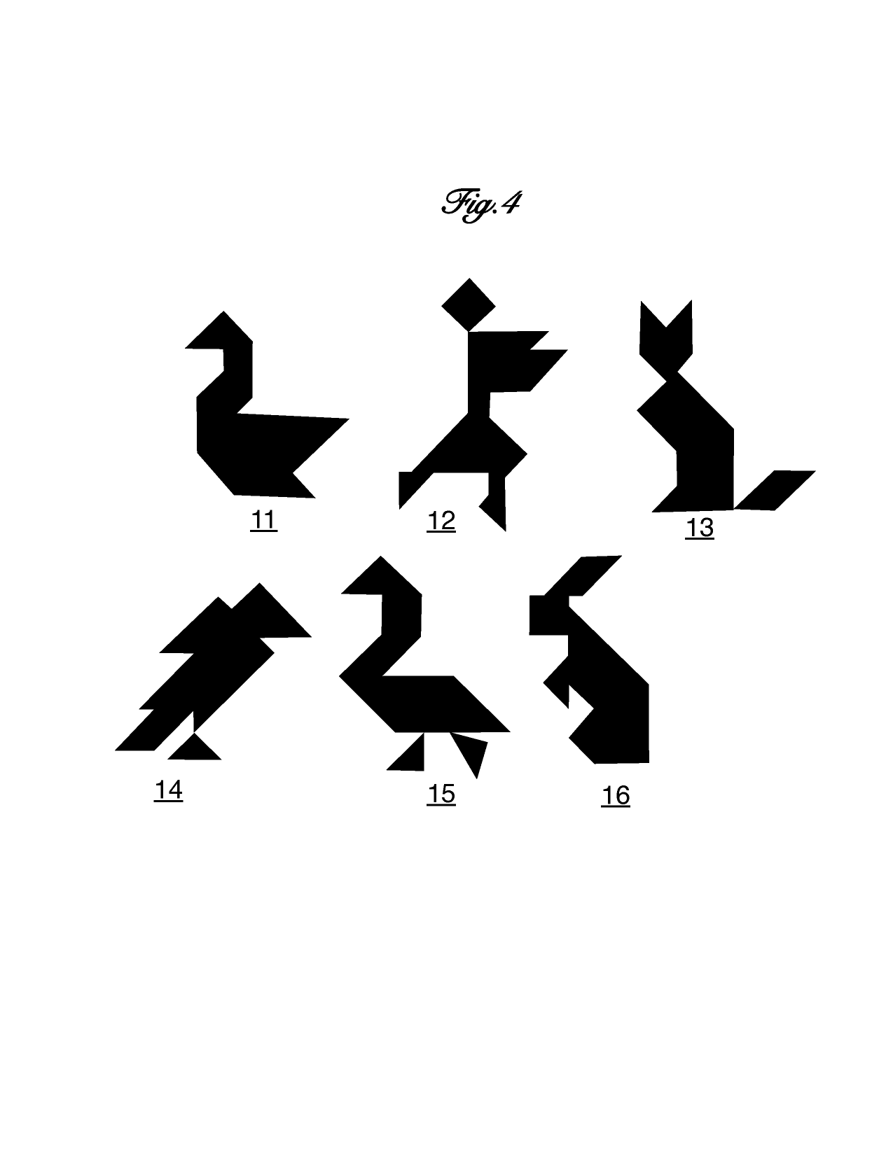

FIG. 2A and 2B illustrates the top view packing shape for alternative tiling puzzles: The heart packing shape (FIG. 2A) and the oval packing shape (FIG. 2B)

FIG. 3 illustrates the packing shape and top view dimensions for the modified nine Tangram tiling pieces (tans), where the two large triangles are split in half forming four smaller triangles for a total of five mid-size triangles, 2 small triangles, one square, and one rhomboid where ‘x’ can be a measurement from 0.5 cm to 100 cm

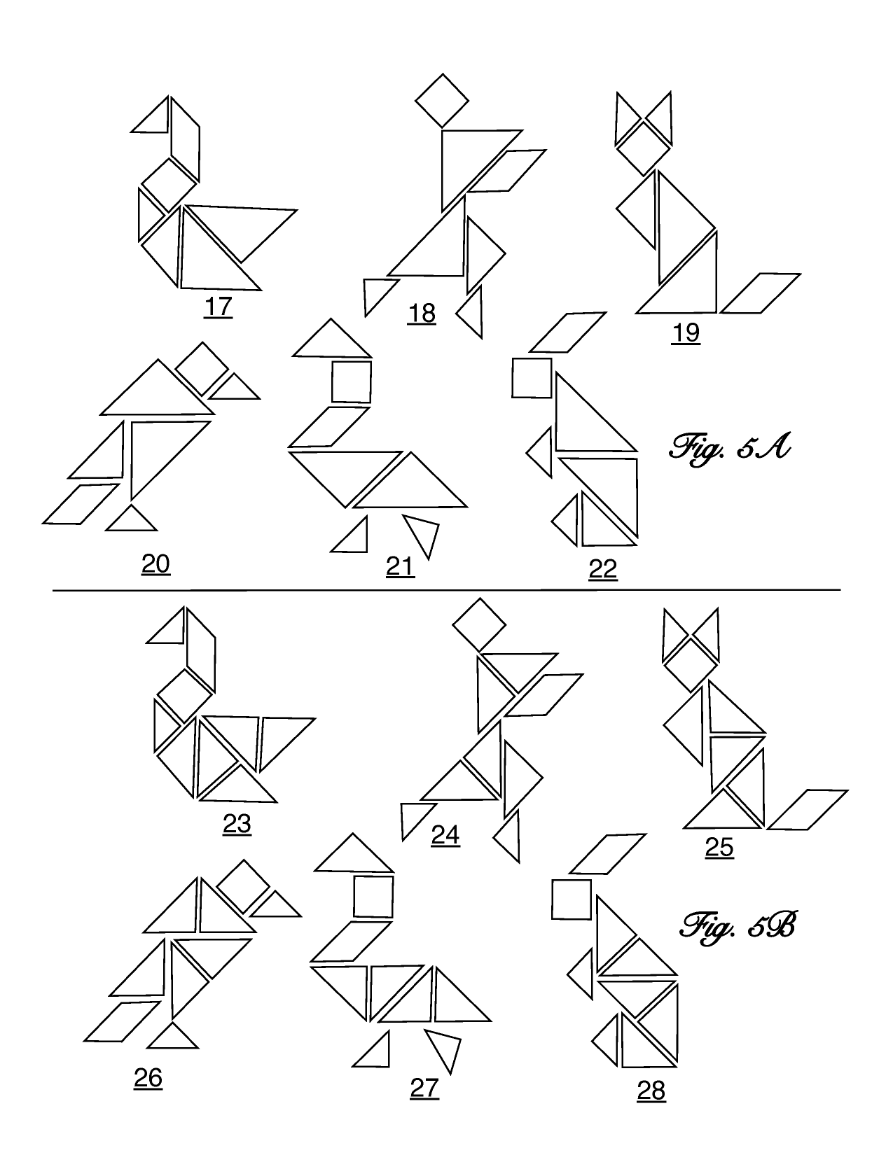

FIG. 4 (11-16) illustrates the challenge for an array of different final shapes created utilizing all of the Tangram tiling pieces (tans)

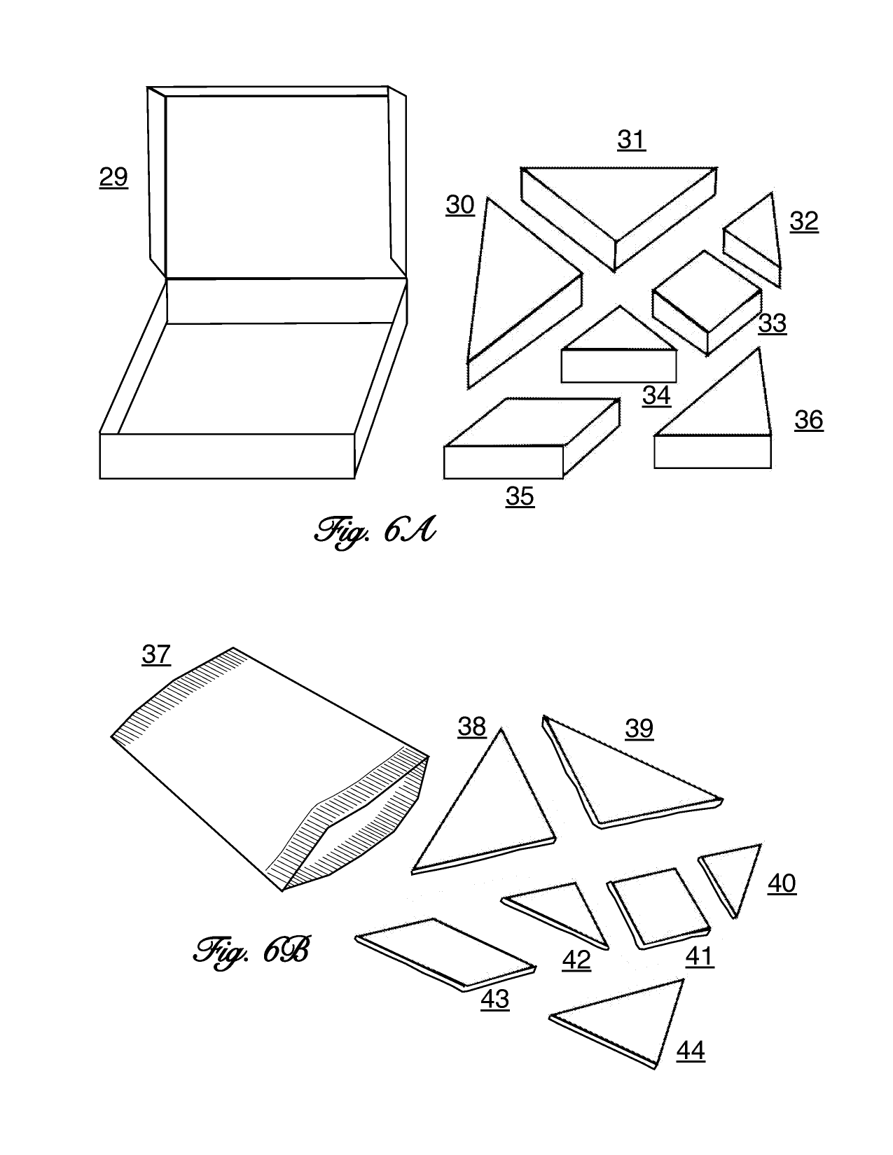

FIG. 5A (17-22)) illustrates the solution for an array of different final shapes created from the basic seven Tangram tiling pieces (tans) with spaces between the tiling pieces (tans)

FIG. 5B (23-29) illustrates the solution for an array of different final shapes created from the modified nine Tangram tiling pieces (tans) with spaces between the tiling pieces (tans)

FIG. 6A illustrates the box package (29) and basic seven processed food Tangram tiling pieces (tans) (30-36) removed

FIG. 6B illustrates the wrapper package (37) and basic seven processed food Tangram tiling pieces (tans) (38-44) removed

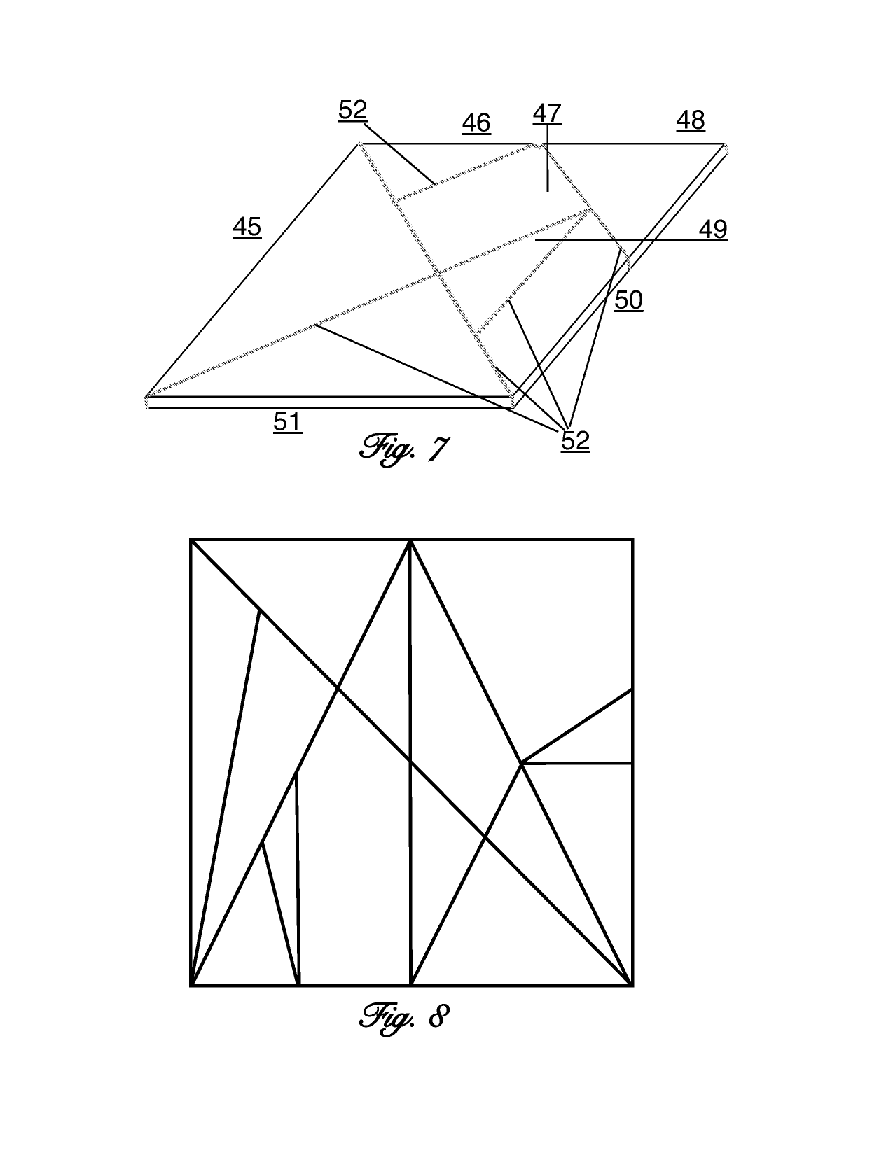

FIG. 7 illustrates the oblique view of the partially attached basic seven processed food Tangram tiling pieces (tans) (45-51), such as a cracker

FIG. 8 illustrates the top view of the alternative (Ostomachion) processed food tiling puzzle made up of fourteen geometric tiling pieces

Tiling puzzles are puzzles in which a number of tiling pieces of roughly the same or similar thicknesses are assembled to form a larger given shape without overlaps. Some tiling puzzles, such as jigsaw puzzles, are made up of interlocking pieces, which can only be assembled in one way. Other tiling puzzles are primarily made up of a set simple convex pieces, which can be arranged in many configurations to create a number of desired final shapes. These are generally called dissection or transformation puzzles.

Variations of the invention relate generally to dissection or transformation puzzles. A dissection puzzle, also called a transformation puzzle, is a tiling puzzle where a solver is given a set of tiling pieces that can be assembled in different ways to produce two or more distinct of the final shapes.

Two of the most famous dissection or transformation puzzles are an Ostomachion (an ancient Greek puzzle attributed to Archimedes, typically made up of 14 geometric shapes, or tiling pieces) (FIG. 8) and a Tangram : an ancient Chinese puzzle, typically made up of seven geometric tiling pieces, or tans (FIG. 1). To learn more about the history Tangram Puzzle, refer to The Tangram Book by Jerry Slocum, Sterling, 2003. The contents of this book are incorporated in this patent by reference.

Various embodiments of this invention provide processed food products, in the shape of a Tangram puzzle made up of Tangram tiling pieces (tans), or other tiling puzzles. Possible benefits include play-value or presentation. For example, one such processed food product can include seven pieces, in which each piece is shaped as a respective Tangram tiling piece (FIG. 6A, 29-36) or (FIG. 6B, 37-44).

A processed food product includes a solid or semi-solid edible material that retains the approximate shape of the individual tiling pieces, such as, but not limited to: baked foods (graham cracker, cracker, cookie, brownie, cake); confectionary foods (chocolate, candy, fruit snacks, granola bar); meats (deli meats, or chicken nuggets; cheese (brick or sliced) or flavored gelatin.

A basic Tangram (FIG. 1) is a dissection puzzle consisting of seven geometric shaped tiling pieces, also called tans:

Specifically, where ‘x’ can be a measurement from 1 cm to 100 cm, the seven tiling pieces (tans) of the basic Tangram are:
two large right triangles, both with hypotenuse length 2x, sides of length x√2, and area x²
one medium right triangle with hypotenuse length x√2, sides of length x, and area x²/2
two small right triangle with hypotenuse length x, sides of length (x√2)/2, and area x²/4,
one square with sides of length (x√2)/2 and area x²/2, and
one parallelogram with a pair of sides of length ‘x’, and a pair of sides of length (x√2)/2, and area x²/√2

A modified Tangram (FIG. 3) is a dissection puzzle consisting of nine geometric shaped tiling pieces, also called tans, where the two large triangles of the basic Tangram are split in half, forming four triangles which are the same size as the medium triangle above:

Specifically, where ‘x’ can be a measurement from 1 cm to 100 cm the nine tans of the modified Tangram are:
five medium right triangles with hypotenuse length x√2, sides of length ‘x’, and area x²/2
two small right triangle with hypotenuse length ‘x’, sides of length (x√2)/2, and area x²/4
one square with sides of length (x√2)/2 and area x²/2, and one parallelogram with a pair of sides of length ‘x’, a pair of sides of length (x√2)/2, and area x²/√2

A packing shape is the most compact shape created by placing all tiling pieces (tans) of the Tangram puzzle set, or all of the tiling pieces of a tiling puzzle, on a single plane. The packing shape contains no overlaps and contains no gaps.

If a set of all seven (or nine) Tangram tiling pieces (tans) has a common scaling factor, then this means that the set can be assembled to form the packing shape of a square (FIG. 1) that has sides each of length of 2x. Alternatively, the set can be assembled to form the packing shape of two squares (FIG. 1A) that each have the sides of x√2, or to form the packing shape of a rectangle (FIG. 1B) in the dimensions of x√2 and 2x√2.

Because it is virtually impossible to construct processed food products with exact dimensions, each of pieces should have dimensions within 15% of the specified dimensions. Therefore, if for a particular processed food product one of the tans has height (y) dimensions such that y=3 centimeters, another piece can have dimensions such that y=3.45 centimeters. Or if one of the small triangles has a hypotenuse such that x=5 centimeters, the other small triangle can have a hypotenuse such that x=5.05.

There exist also alternative tiling puzzles, including one which is comprised of eight tiling pieces which have a common scaling factor such that the set can be assembled to form a packing shape of a heart (FIG. 2A); and another alternative tiling puzzle which is comprised of nine tiling pieces which have a common scaling factor such that the set can be assembled to form a packing shape of an oval (FIG. 2B). Each of these alternative tiling puzzle pieces can also be rearranged to create a number of the final shapes.

If all tiling puzzles have a common scaling factor, then this means that the set can be assembled to form the compact packing shape. Each of the tiling puzzle pieces can also be rearranged to create a number of the final shapes.

An arrangement of the seven (or nine) Tangram tiling pieces (tans), or the arrangement the tiling pieces of a tiling puzzle, is a manner of laying all of the tiling pieces near each other to form the final shape such as a convex polygon, an animal, figure, letter from the alphabet, or a number. Typically the arrangement of the tiling pieces does not have a tiling piece overlapping another tiling piece, and often every tiling piece (tan) abuts, or touches, at least one other tiling piece.

Generally a dissection or transformation puzzle challenge (FIG. 4) is presented as an outline or silhouette of the final shape, with the interior, junction lines of the individual tiling pieces erased. The solver is invited to arrange all of the tiling pieces with all of the tiling pieces abutting or touching another piece, in order to create the desired final shape. A puzzle solution (FIG. 5A, 5B) shows the lines that mark the edge of the tiling pieces, or spaces separating the individual tiling pieces.

A play value usually relates to the activity of assembling the Tangram tiling pieces (tans), or other tiling pieces, to form the desired final shape. The puzzle is presented as the challenge (FIG. 4). The consumer is challenged to recreate the same outline final shape utilizing all seven (or nine) of the Tangram tiling pieces (tans), or other tiling pieces from other tiling puzzles. The consumer may thus engage in the puzzle activity with the tiling pieces, before consuming them.

A presentation usually relates to the activity of displaying processed food products in a decorative manner. The decorative final shape is presented in the form of a solution (FIG. 5A, 5B). The brownie or cakes pieces, in the Tangram tiling piece (tan) shapes, or other tiling pieces for other tiling puzzles, would be rearranged on a surface, to recreate the decorative final shape. The consumer may thus arrange the tiling pieces for the decorative effect before it is consumed.

The edible Tangram tiling pieces (tans), or other tiling pieces for other tiling puzzles, can be packaged in a square box comprised of a sturdy base, rigid sides, and a hinged top, or a top that fits over the top of the box. The seven (or nine) Tangram tiling pieces (tans), or other tiling pieces for other tiling puzzles, are placed to fit within in the square packing shape configuration.

The edible Tangram tiling pieces (tans), or other tiling pieces for other tiling puzzles, can be packaged in a flexible wrapper comprised of a flexible paper or foil or other cylinder, which is sealed at both ends. The seven (or nine) Tangram tiling pieces (tans), or other tiling pieces for other tiling puzzles, are loose within the sealed wrapper.

The edible Tangram tiling pieces (tans), or other tiling pieces for other tiling puzzles, can packaged in the flexible wrapper with a sturdy base, comprised of a flexible paper or foil or other cylinder, sealed a both ends, and a rigid rectangular, or other shaped, piece of cardboard inserted into the wrapper. The seven (or nine) Tangram tiling pieces (tans), or other tiling pieces for other tiling puzzles, are semi-attached, resting on the cardboard base and sealed within the wrapper.

The edible Tangram tiling pieces, or the tiling pieces of any tiling puzzle, can be partially attached to each other, in the packing shape. For example, a square cracker could have ridges demarking the attached edges of the Tangram tiling pieces (tans). The individual tiling pieces are snapped apart applying torque along the ridges.

The tiling puzzle challenge(s) can be printed on the outside of the package, or on an insert placed inside the package. The tiling puzzle solution(s) can be printed on the outside of the package, on the inside of the package, or on the insert inside the package. Tiling puzzle challenges and solutions can also be posted on an associated website or phone app.

Referring now to FIG. 1, there is shown the top view square packing shape for the basic Tangram made of seven tiling pieces (tans) of a processed food product, The tiling pieces (tans) in each set are the same height of the processed food product. The tiling pieces can be similar heights to each other, for example: all 2 centimeters (such as a slice of cheese or a graham cracker) or all 10 cm (such as a layer cake). The basic Tangram set is composed of two larger triangles, two smaller triangles, one mid-sized triangle, one square and one parallelogram.

Referring now to FIG. 1A, there is shown the top view for a packing shape consisting of two squares for the basic Tangram puzzle made of seven tiling pieces (tans) of the processed food product.

Referring now to FIG. 1B, there is shown a top view for the rectangular packing shape for the basic Tangram made of seven tiling pieces (tans) of a processed food product.

Referring now to FIGS. 2A and 2B, there is shown the top view packing shape for alternative tiling puzzles: 2A, the heart packing shape for a processed food product, and 2B, the oval packing shape for a processed food product

Referring now to FIG. 3, there is shown the top view packing shape for the modified Tangram made of nine tiling pieces (tans) of the processed food product. The nine tiling pieces (tans) in each set are the same height of the processed food product. The tiling pieces can all be similar heights to each other, for example: all approximately 2 centimeters (such as a slice of cheese or a graham cracker) or all approximately 10 cm (such as a layer cake). The modified Tangram set is composed of five mid-sized triangles, two smaller triangles, one square and one parallelogram.

Referring now to FIG. 4 (11-16), there is shown six different challenges as an outline or silhouette of the final shapes, with the interior, junction lines of the individual tiling pieces erased.

Referring now to FIG. 5A (17-22), there is shown six final shapes created by the basic seven processed food Tangram tiling pieces (tans), with the tans slightly spaced from each other. FIG. 5B (23-28), there is shown six final shapes created by the modified nine processed food Tangram tiling pieces (tans), with the tans slightly spaced from each other. One seeing these illustrations would learn how to recreate the same final shapes, since the tans are distinctly defined. These figures therefore represent the Tangram solutions.

Referring now to FIG. 6A there is shown the basic seven processed food Tangram tiling pieces (tans) taken out of their packages: The box (29) with the basic seven cake Tangram tiling pieces (30-36) removed from the box; and the wrapper (37) with the basic seven cracker Tangram tiling pieces (38-44) removed from the wrapper. After the individual processed food Tangram tiling pieces (tans) have been removed from the package, they can be rearranged into final shapes, as previously described, and in advance of them being consumed.

Referring now to FIG. 7, there is shown a full set of basic seven processed food Tangram tiling pieces (tans) (45-51), partially attached in a square. When the processed food product, such as a cracker, is snapped apart along the ridges (52) the individual tiling pieces (tans) are separated from the square.

Referring now to FIG. 8, there is shown the top view of one of many alternative tiling puzzles. This one, also called an Ostomachion puzzle, is made up of 14 geometric tiling pieces.

What is claimed is:

1. A product comprising:
a basic Tangram tiling puzzle,
wherein the tiling puzzle comprises seven tiling pieces,
wherein the tiling pieces are made of a processed graham cracker,
wherein the tiling pieces fit within a square packing shape,
wherein the square packing shape is between 25 square centimeters and 225 square centimeters.

2. A product comprising:
a tiling puzzle composed of a processed food product,
wherein the tiling puzzle comprises a plurality of tiling pieces,
wherein all of the tiling pieces have a common scaling factor such when configured together, they can fit into a packing shape.

3. the product of claim 2,
wherein there are seven tiling pieces,
wherein each of the seven tiling pieces (tans) is shaped as a respective basic Tangram tiling piece.

4. the product of claim 2,
wherein there are nine tiling pieces,
wherein each of the nine tiling pieces (tans) is shaped as a respective modified Tangram tiling piece.

5. the product of claim 2,
wherein there are fourteen tiling pieces,
wherein each of the fourteen tiling pieces is shaped as a respective Ostomachion tiling piece.

6. the product of claim 2,
wherein the tiling pieces are made of a processed food product that retains the approximate shape of the tiling pieces

7. the product of claim 2,
wherein each of the tiling pieces has a thickness of between 0.1 millimeters and 30 centimeters,
wherein the thickness of each of the tiling pieces within a tiling puzzle set is within 15% of the thickness every other piece.

8. the product of claim 2,
wherein the tiling pieces within the tiling puzzle set collectively have a total square area of between 4 square centimeters and 10,000 square centimeters.

9. the product of claim 2,
wherein there are multiple sets of the tiling puzzle.

10. the product of claim 2,
wherein there are additional processed food products packed together with the tiling pieces.

11. the product of claim 2,
wherein each of the tiling pieces is a different color.

12. the product of claim 2,
wherein the tiling pieces are partially attached.

13. the product of claim 2,
wherein each of the tiling pieces has a layer of icing on one face.

14. the product of claim 13,
wherein each of the tiling pieces has the layer of icing that has a different color than the icing of the other tiling pieces.

15. the product of claim 2,
further comprising a package in which the tiling pieces are enclosed.

16. the product of claim 15,
wherein the package comprises a box.

17. the product of claim 15,
wherein the package comprises a wrapper.

18. the product of claim 15,
wherein the package includes printing thereon,
wherein the printing depicts the challenge for one or more final shape arrangements of the tiling puzzle,
wherein the printing depicts the solution for one or more final shape arrangements of the tiling puzzle.

19. the product of claim 15,
wherein the challenge is printed on an insert placed within the package,
wherein the solution is printed on an insert placed within the package.

20. the product of claim 15,
wherein the challenge is included in an associated web page or phone app,
wherein the solution is included in an associated web page or phone app.
